(19) United States
(12) Patent Application Publication
(10) Pub. No.: US 2003/0109282 A1
(43) Pub. Date: Jun. 12, 2003

(54) Method and base station for providing phase-shift transmit diversity

(76) Inventors: Itzhak Shperling, Bnei-Brak (IL); Shlomo Barash, Holon (IL); Sergey Bondarenko, Ramat Gan (IL); Reuven Meidan, Ramat Hasharon (IL)

Correspondence Address: MARSHALL, GERSTEIN & BORUN (MOTOROLA), 233 SOUTH WACKER DRIVE, SUITE 6300, CHICAGO, IL, 60606-6402, US

(21) Appl. No.: 10/008,332

(22) Filed: Dec. 6, 2001

(51) Int. Cl. H04M 1/00

(52) U.S. Cl. 455/561; 455/42; 455/283

(57) ABSTRACT

In accordance with the preferred embodiments of the present invention, a method (400) and a base station (140) for providing phase-shift transmit diversity in a wireless communication system are described herein. The base station (140) phase-shift modulates a first signal with a reference signal to produce a first phase-shift modulated signal including a first phase shift. Further, the base station phase-shift modulates a second signal with the reference signal to produce a second phase-shift modulated signal including a second phase shift. The second phase shift is distinct from the first phase shift such that the second phase-shift modulated signal is diverse relative to the first phase-shift modulated signal. Accordingly, the base station transmits the first phase-shift modulated signal via a first antenna and the second phase-shift modulated signal via a second antenna to a plurality of mobile stations.

### FIELD OF THE INVENTION

The present invention relates to wireless communication systems, and more particularly, to a method and a base station for providing phase-shift transmit diversity in a wireless communication system.

### BACKGROUND OF THE INVENTION

A wireless communication system is a complex network of systems and elements. Typically elements include (1) a radio link to the mobile stations (e.g., cellular telephones), which is usually provided by at least one and typically several base stations, (2) communication links between the base stations, (3) a controller, typically one or more base station controllers or centralized base station controllers (BSC/CBSC), to control communication between and to manage the operation and interaction of the base stations, (4) a call controller (e.g., mobile switching center (MSC)) or switch, typically a call agent (i.e., a “softswitch”), for routing calls within the system, and (5) a link to the land line or public switch telephone network (PSTN), which is usually also provided by the call agent.

One aspect of designing a wireless communication system is to optimize the performance of forward link or downlink transmissions. That is, the voice and packet data transmissions from a base station to a mobile station. However, multipath fading may cause multiple copies of the transmissions to be received at the mobile station with time-varying attenuation, phase shift and delay because of multiple reflections on the path.

One technique to mitigate the effects of multipath fading in a wireless communication channel is error correcting code. Along with error correction code, bit interleaving can compensate for bit errors caused by multipath fading. In particular, bit interleaving scatters the bit errors among the uncorrupted bits (i.e., “good” bits) so that the error correction codes can better correct the error bits interspersed among the “good” bits. However, the fading intervals must be fast enough to cause a burst of bit errors that are much shorter than the bit interleaving period (i.e., a frame) for bit interleaving to be effective. For example, a slow moving mobile station (e.g., a mobile station used by a pedestrian or an in-building user) creates slow fading receiving channels such that fading bursts on the wireless communication channel are longer than the frame. As a result, the error correction code may not compensate for the error bits.

Diversity is another technique used to reduce the effect of multipath fading. In particular, multiple antennas at the reception end, e.g., the mobile station, may be used to combine, select and/or switch to improve the quality of the transmission from the transmission end, e.g., the base station. However, receive diversity techniques increase cost, size, and power consumption of the mobile station.

Forward link or downlink performance may be optimized by implementing diversity on the transmission end. In particular, phase-shift transmit diversity (PSTD) may be implemented to reduce multipath fading effects. To provide PSTD, a base station generally includes a signal source, a transmitting unit, a signal split element, a phase-shift element, a main antenna and a diversity antenna. A basic flow for providing PSTD may start with the signal source providing a baseband signal to the transmitting unit, which in turn modulates the baseband signal to produce a radio frequency (RF) signal and amplifies the RF signal with a power amplifier. The signal splitter separates the RF signal into two paths, i.e., a main path and a diversity path. The main antenna transmits the RF signal on the main path whereas the RF signal on the diversity path is phase-shift modulated by the phase-shift element to produce a phase-shift modulated RF signal. Typically, the phase-shift element may be a high-power handling, slow changing 360 phase-shift element. That is, the RF signal on the diversity path (i.e., the phase-shift modulated RF signal) may be phase-shift modulated relative to the RF signal on the main path such that the phase shifts a full cycle from 0 to 360 at least once during a frame. Accordingly, the diversity antenna coupled to the phase-shift element transmits the phase-shift modulated RF signal. However, the phase-shift element suffers from high insertion loss variation and non-linear phase change (e.g., hysteresis and temperature variation effects).

In an alternate method to implement PSTD, the base station may include two separate power amplifiers. Prior to the power amplifiers, a RF signal may be separated into two signals for a main path and a diversity path, i.e., a main signal and diversity signal, respectively. On the main path, the main signal may be amplified and transmitted via a main antenna. On the diversity path, the diversity signal may be phase-shift modulated (i.e., applying a time-varying phase shift) prior to being amplified and transmitted via a diversity antenna. However, cost of the base station may increase because of the additional power amplifier. Therefore, a need exists for implementing phase-shift transmit diversity that minimizes the insertion loss variation and the phase non-linearities.

Another aspect of designing a wireless communication system is to increase the capacity of the system by adding carriers to existing infrastructure as needed. That is, several carriers may be combined at the same location but each carrier may be individually amplified and modulated with voice and data information. One method for carrier combination is to use a resistive or hybrid combiner at a high radio frequency (RF) power level for transmission through a common antenna. However, this method loses more than half of the transmission power because of resistive losses in the hybrid combiner. Another method for carrier combination is to use a high power frequency multiplexer for transmission through a common antenna. Even though this method typically has a low power loss, the use of a high power frequency multiplexer may be limited to non-adjacent carriers because of filter limitations. Another method for carrier combination is space combination in which a main carrier is transmitted via a main antenna and adjacent carriers are transmitted via a diversity antenna. This method also has a low power loss, but the difference in radiation patterns between the main antenna and the diversity antenna may cause uneven carrier loading and below capacity use of the communication system.

Therefore, a need exists for carrier combination with low power loss at high RF power level for transmission of both adjacent and non-adjacent carriers via a common antenna.

### BRIEF DESCRIPTION OF THE DRAWINGS

FIG. 1 is a block diagram representation of a wireless communication system that may be adapted to operate in accordance with the preferred embodiments of the present invention.

FIG. 2 is a block diagram representation of a base station that may be adapted to operate in accordance with the preferred embodiments of the present invention.

FIG. 3 is a block diagram representation of a phase-shift unit that may be adapted to operate in accordance with the preferred embodiments of the present invention.

FIG. 4 is a flow diagram illustrating a method for providing phase-shift transmit diversity in accordance with the preferred embodiments of the present invention.

### DETAILED DESCRIPTION OF THE PREFERRED EMBODIMENTS

Preferred embodiments of a method and a base station for providing phase-shift transmit diversity in a wireless communication system are described. The wireless communication system provides communication services to a plurality of mobile stations. In particular, a base station provides phase-shift transmit diversity by phase-shift modulating a first signal S₁ with a first control signal to produce a first phase-shift modulated signal S₁*exp(−j θ₁), where first phase shift θ₁(t)=C₁+P₁(t) includes a first constant phase C₁ and a time-varying phase shift P₁(t)=P₁(m₁(t)). Further, the base station phase-shift modulates a second signal S₂ with a second control signal to produce a second phase-shift modulated signal S₂*exp(−j θ₂), where second phase shift θ₂(t)=C₂+P₂(t) includes a second constant phase shift C₂ and a time-varying phase shift P₂(t)=P₂(m₂(t)). The second phase shift is distinct from the first phase shift such that the second phase-shift modulated signal is diverse relative to the first phase-shift modulated signal. That is, the first phase shift may be a phase shift of 180 peak deviation operable in a first direction whereas the second phase shift may be a phase shift of 180 peak deviation operable in a second direction to generate a time-varying relative phase shift from −180 to 180. In the same cycle, for example, the first phase shift may be a phase shift of 180 peak deviation operable in an ascending direction (i.e., from 0 to 180) whereas the second phase-shift modulated signal may include a phase shift of 180 peak deviation operable in a descending direction (i.e., 180 to 0). In another example, a first constant phase shift deviation C₁ may be added to the first phase shift and a second constant phase shift deviation C₂ may be added to the second phase shift to generate a relative phase shift between −180+ΔC and 180+ΔC, where ΔC=C₁−C₂ is the phase difference. Accordingly, the base station transmits the first phase-shift modulated signal via a first antenna and the second phase-shift modulated signal via a second antenna to the plurality of mobile stations.

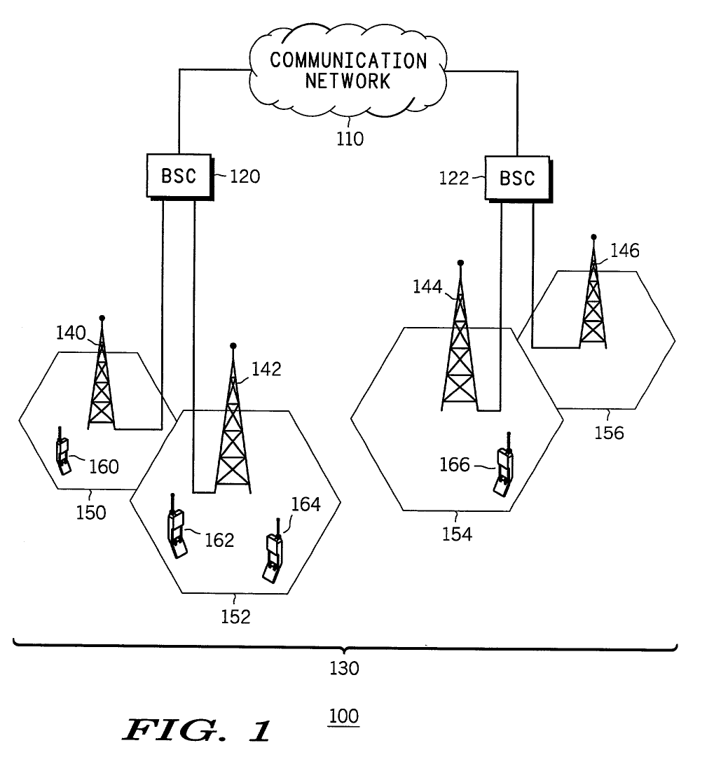

A communication system in accordance with the present invention is described in terms of several preferred embodiments, and particularly, in terms of a wireless communication system operating in accordance with at least one of several standards. These standards include analog, digital or dual-mode communication system protocols such as, but not limited to, the Advanced Mobile Phone System (AMPS), the Narrowband Advanced Mobile Phone System (NAMPS), the Global System for Mobile Communications (GSM), the IS-55 Time Division Multiple Access (TDMA) digital cellular, the IS-95 Code Division Multiple Access (CDMA) digital cellular, CDMA 2000, the Personal Communications System (PCS), 3G and variations and evolutions of these protocols. As shown in FIG. 1, a wireless communication system 100 includes a communication network 110, a plurality of base station controllers (BSC), generally shown as 120 and 122, servicing a total service area 130. The wireless communication system 100 may be, but is not limited to, a frequency division multiple access (FDMA) based communication system, a time division multiple access (TDMA) based communication system, and code division multiple access (CDMA) based communication system. As is known for such systems, each BSC 120 and 122 has associated therewith a plurality of base stations (BS), generally shown as 140, 142, 144, and 146, servicing communication cells, generally shown as 150, 152, 154, and 156, within the total service area 130. The BSCs 120 and 122, and base stations 140, 142, 144, and 146 are specified and operate in accordance with the applicable standard or standards for providing wireless communication services to mobile stations (MS), generally shown as 160, 162, 164, and 166, operating in communication cells 150, 152, 154, and 156, and each of these elements are commercially available from Motorola, Inc. of Schaumburg, Ill.

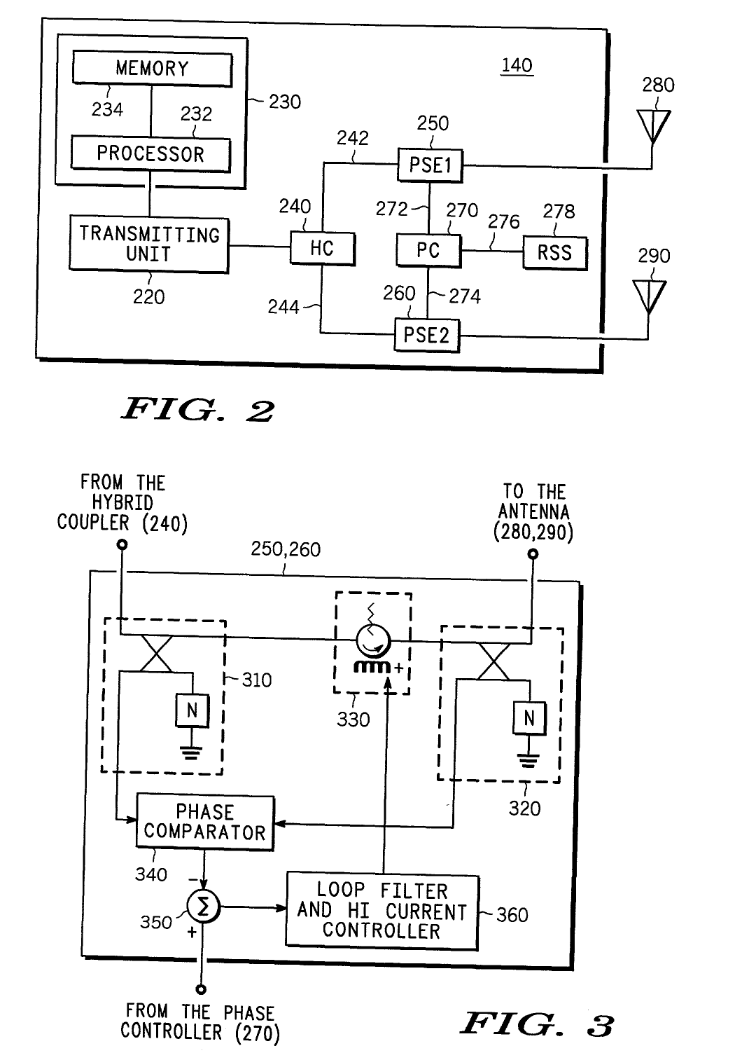

Referring to FIG. 2, the base station 140 generally includes a transmitting unit 220, a controller 230, a hybrid coupler (HC) 240, a first phase-shift element (PSE1) 250, a second phase-shift element (PSE2) 260, a phase controller (PC) 270, a first antenna 280, and a second antenna 290. The transmitting unit 220 is operatively coupled to the controller 230, which includes, but is not limited to, a processor 232 and a memory 234. The processor 232 is operatively coupled to the memory 234, which stores a program or a set of operating instructions for the processor 232. In particular, the processor 232 executes the program or the set of operating instructions such that the base station 140 operates in accordance with a preferred embodiment of the invention. The program or the set of operating instructions may be embodied in a computer-readable medium such as, but not limited to, paper, a programmable gate array, application specific integrated circuit, erasable programmable read only memory, read only memory, random access memory, magnetic media, and optical media. Further, the transmitting unit 220 is operatively coupled to the hybrid coupler 240 as one of ordinary skill in the art will readily recognize. The hybrid coupler 240 and the phase controller 270 are operatively coupled to the first phase-shift element 250 and the second phase-shift element 260. In particular, the hybrid coupler 240 provides a first signal via a first path 242 to the first phase-shift element 250 and a second signal via a second path 244 to the second phase-shift element 260. The phase controller 270 provides a first control signal via a first control path 272 to the first phase-shift element 250 and a second control signal via a second control path 274 to the second phase-shift element 260. The first and second control signals are time synchronized to a reference signal 276 provided by a reference signal source (RSS) 278, e.g., a base station reference clock and an internal high accuracy oscillator. The reference signal 276 may be, but is not limited to, an integer multiple of 1.2288 MHz (i.e., the IS-95 CDMA chip rate), and an integer multiple of 50 Hz (i.e., the IS-95 CDMA frame rate). For example, the reference signal may be 19.6 MHz, which is 16 times 1.2288 MHz. The first phase-shift element 250 is operatively coupled to the first antenna 280 whereas the second phase-shift element 260 is operatively coupled to the second antenna 290. The first phase-shift element 250 and the second phase-shift element 260 may be, but are not limited to, an open loop calibration circuit operable by a digital and/or analog means, and a closed loop compensation circuit as described in further detail below.

To provide phase-shift transmit diversity, the base station 140 transmits a first phase-modulated signal via the first antenna 280 (e.g., a main antenna) and a second phase-modulated signal via the second antenna 290 (e.g., a diversity antenna). The first phase-shift element 250 generates the first phase-shift modulated signal based on the first signal via the first path 242 and the first control signal via the first control path 272 whereas the second phase-shift element 260 generates the second phase-shift modulated signal based on the second signal via the second path 244 and the second control signal via the second control path 274. That is, a first phase shift is added to the first signal to produce the first phase-shift modulated signal, and a second phase shift is added to the second signal to produce the second phase-shift modulated signal. In particular, the second phase shift is distinct from the first phase shift such that the second phase-shift modulated signal is diverse relative to the first phase-modulated signal. The first phase shift may be, but is not limited to, a phase shift of 180 peak deviation operable in a first direction, and the second phase shift may be, but is not limited to a phase shift of 180 peak deviation operable in a second direction. That is, the first phase shift and the second phase shift are operable in opposite directions from one another. For example, the first phase shift may be a phase shift from 0 to 180 (i.e., in an ascending direction) whereas the second phase shift may be a phase shift from 180 to 0 (i.e., in a descending direction). In another example, the first phase shift may be a phase shift from 90 to 270 (i.e., in an ascending direction) whereas the second phase shift may be a phase shift from 225 to 45 (i.e., in a descending direction). The first and second phase modulated signals may span over more than one carrier. As a result, a mobile station may receive the first and second phase-shift modulated signals on a first carrier whereas another mobile station may receive the first and second phase-shift modulated signals on a second carrier from a common base station (e.g., base station 140) such that the first and second phase-shift modulated signals on the first and second carriers are diverse relative to each other.

As noted above, the first and second phase-shift elements 250, 260 may be, but are not limited to, an open loop linearization and compensation circuit and a closed loop linearization and compensation circuit (i.e., calibration-free) as shown in FIG. 3. Referring to FIG. 3, each of the first phase-shift element 250 and the second phase-shift element 260 generally includes a first directional coupler 310, a second directional coupler 320, a phase shifter 330, a phase comparator 340, a combination circuit 350 and a loop filter and high current controller 360. The first directional coupler 310 is operatively coupled to the phase comparator 340, which in turn is operatively coupled to the second directional coupler 320 and the combination circuit 350. In particular, the combination circuit 350 is operatively coupled to the loop filter and high current controller 360, which in turn is operatively coupled to the phase shifter 330, which may be, but is not limited to, an 180 ferrite variable phase shifter. The first directional coupler 310 is also operatively coupled to the phase shifter 330, which in turn, is operatively coupled to the second directional coupler 320.

A basic flow for phase-shift modulating a radio frequency (RF) signal that may be applied with the preferred embodiment of the present invention shown in FIG. 3 may start with the phase shifter 330 generating a phase-shift modulated signal based on an RF signal from a hybrid coupler (one shown as 240 in FIG. 2) and an output from the loop filter and high current controller 360 as further described in detail below. In particular, the first directional coupler 310 provides a sample of the input to the phase shifter (i.e., the RF signal) to the phase comparator 340. Also, the second directional coupler 320 provides a sample of the output of the phase shifter 330 (i.e., the phase-shift modulated signal) to the phase comparator 340. Accordingly, the phase comparator 340 generates an output signal that is proportional to the phase difference between the sample of the RF signal from the first directional coupler 310 and the sample of the phase-shift modulated signal from the second directional coupler 320. In response to the output signal from the phase comparator 340, the combination circuit 350 generates an error signal based on a control signal from a phase controller (one shown as 270 in FIG. 2). The loop filter and high current controller 360 filters and amplifies the error signal to generate a control signal to the phase shifter 330. As a result, the phase shifter 330 generates the phase-shift modulated signal based on the control signal from the loop filter and high current controller 360. Thus, the phase shifter 330 provides the phase-shift modulated signal to the antenna (e.g., the first antenna 280 and the second antenna 290) for transmission to a mobile station.

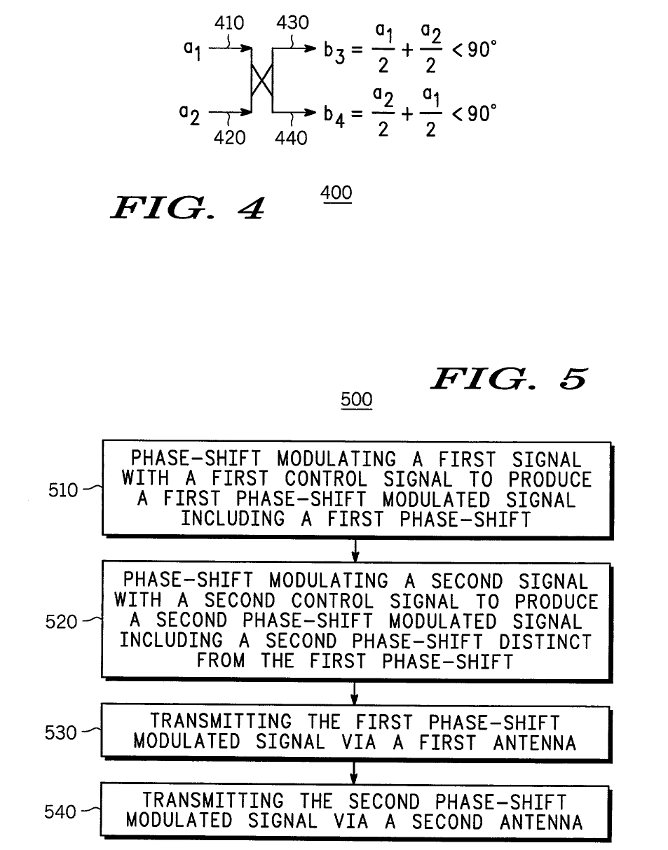

In an alternate embodiment, the hybrid coupler shown as 240 in FIG. 2 may be a four-port hybrid combination circuit to provide carrier combination. For example, the four-port hybrid combination circuit may be, but is not limited to, a 90° four-port hybrid combination circuit and a 180° four-port hybrid combination circuit. Referring to FIG. 4, the four-port hybrid combination circuit 400 generally includes a first port 410, a second port 420, a third port 430 and a fourth port 440. The first and second ports 410, 420 may be operatively coupled to transmitting units such as the transmitting unit 220 shown in FIG. 2. The third and fourth ports 430, 440 may be operatively coupled to the first and second paths 242, 244 shown in FIG. 2, respectively.

Referring back to FIG. 4, a basic flow of the four-port hybrid combination circuit 400 may start with the first and second ports 410, 420 receiving two input signals (i.e., a first input signal a₁ and a second input signal a₂) to produce a composite signal, which turn, is separated into a first output signal b₃ and a second output signal b₄ (i.e., the first and second signals via the first and second paths 242, 244, respectively). The first and second output signals b₃, b₄ are linear combination of the first and second input signals a₁ and a₂. For example, the first output signal b₃ may be the first input signal a₁ at half power (i.e., divided by two) combined with the second input signal a₂ at half power and shifted by 90°, and the second output signal b₄ may be the first input signal at half power and shifted by 90° combined with the second input signal a₂ at half power. The third port 430 provides the first signal (i.e., the first output signal b₃) to the first phase-shift element 250 via the first path 242 whereas the fourth port 440 provides the second signal (i.e., the second output signal b₄) to the second phase-shift element 260 via the second path 244. Accordingly, the first and second signals are each phase-shift modulated and transmitted as described above. In particular, the first signal is phase-shift modulated by the first phase-shift element 250 to produce the first phase-shift modulated signal at half power and the second signal is phase-shift modulated by the second phase-shift element 260 to produce the second phase-shift modulated signal at half power. The first and second phase-shift modulated signals are transmitted via the first and second antennas 280, 290 shown FIG. 2, respectively. The carriers of the first and second phase-shift modulated signals are recombined at the mobile station to recover full power of the first and second input signals a₁, a₂.

In accordance with the preferred embodiments of the present invention, and with references to FIG. 5, a method 500 for providing phase-shift transmit diversity in a wireless communication system is shown. Method 500 begins at step 510, where a base station phase-shift modulates a first signal with a first control signal to produce a first phase-shift modulated signal including a first phase shift. In particular, the first phase shift may be, but is not limited to, a first constant phase shift and a time-variable phase shift of 180 peak deviation operable in a phase direction. For example, the first phase-shift modulated signal may include a time-variable phase shift from 0 to 180 in an ascending phase direction. At step 520, the base station phase-shift modulates a second signal with a second control signal to produce a second phase-shift modulated signal including a second phase shift. The first control signal is synchronized with the second control signal. The second phase shift is distinct from the first phase shift such that the second phase-shift modulated signal is diverse relative to the first phase-shift modulated signal. That is, the second phase shift may be, but is not limited to, a second constant phase shift and a second time-variable phase shift of 180 peak deviation operable in a phase direction. For example, the second phase-shift modulated signal may include a phase shift from 180 to 0 in a descending phase direction. At step 530, the base station transmits the first phase-shift modulated signal via a first antenna (e.g., a main antenna). At step 540, the base station transmits the second phase-shift modulated signal via a second antenna (e.g., a diversity antenna). As a result, the base station provides phase-shift transmit diversity with the first and second phase-shift modulated signals.

Many changes and modifications could be made to the invention without departing from the fair scope and spirit thereof. The scope of some changes is discussed above. The scope of others will become apparent from the appended claims.

What is claimed:

1. In wireless communication system, the communication system providing communication services to a plurality of mobile stations, a method for providing phase-shift transmit diversity, the method comprising:
phase-shift modulating a first signal with a first control signal to produce a first phase-shift modulated signal including a first phase shift;
phase-shift modulating a second signal with a second control signal to produce a second phase-shift modulated signal including a second phase shift, the second phase shift being distinct from the first phase shift such that the second phase-shift modulated signal is diverse relative to the first phase-shift modulated signal;
transmitting the first phase-shift modulated signal via a first antenna; and
transmitting the second phase-shift modulated signal via a second antenna,
wherein the first control signal is synchronized with the second control signal.

2. The method of claim 1, wherein the step of phase-shift modulating a first signal with a first control signal to produce a first phase-shift modulated signal including a first phase shift comprises phase-shift modulating a first signal with a first control signal to produce a first phase-shift modulated signal including a first constant phase shift and a first time-variable phase shift of 180 peak deviation operable in a phase direction.

3. The method of claim 1, wherein the step of phase-shift modulating a first signal with a first control signal to produce a first phase-shift modulated signal including a first phase shift comprises phase-shift modulating a first signal with a first control signal to produce a first phase-shift modulated signal including a first constant phase shift and a first time-variable phase shift of 180 peak deviation operable in an ascending phase direction.

4. The method of claim 1, wherein the step of phase-shift modulating a second signal with a second control signal to produce a second phase-shift modulated signal including a second phase shift comprises phase-shift modulating a second signal with a second control signal to produce a second phase-shift modulated signal including a second constant phase shift and a second time-variable phase shift of 180 peak deviation operable in a phase direction.

5. The method of claim 1, wherein the step of phase-shift modulating a second signal with a second control signal to produce a second phase-shift modulated signal including a second phase shift comprises phase-shift modulating a second signal with a second control signal to produce a second phase-shift modulated signal including a second constant phase shift and a second time-variable phase shift of 180 peak deviation operable in a descending phase direction.

6. The method of claim 1, wherein the step of transmitting the first signal via a first antenna comprises transmitting the first phase-shift modulated signal via a main antenna.

7. The method of claim 1, wherein the step of transmitting the second signal via a second antenna comprises transmitting the second phase-shift modulated signal via a diversity antenna.

8. The method of claim 1 further comprising the steps of:
combining a first input signal and a second input signal to produce a composite signal; and
generating the first signal and the second signal based on the composite signal,
wherein the first signal is based on a first carrier and the second signal is based on a second carrier.

9. The method of claim 1, wherein the communication system operates in accordance with a code division multiple access (CDMA) based communication protocol.

10. In a wireless communication system, the communication system providing communication services to a plurality of mobile stations, an apparatus for providing phase-shift transmit diversity, the apparatus comprising:
a first signal path operable to provide a first signal;
a second signal path operable to provide a second signal;
a phase-shift controller adapted to provide a first control signal and a second control signal, the first control signal being synchronized with the second control signal;
a first phase-shift element coupled to the first signal path and the phase-shift controller, the first phase-shift element being operable to generate a first phase-shift modulated signal including a first phase shift based on the first signal and the first control signal;
a second phase-shift element coupled to the second signal path and the phase-shift controller, the second phase-shift element being operable to generate a second signal including a second phase shift based on the second signal and the second control signal;
a first antenna coupled to the first phase-shift element, the first antenna being operable to transmit the first phase-shift modulated signal; and
a second antenna coupled to the second phase-shift element, the second antenna being operable to transmit the second phase-shift modulated signal,
wherein the second phase shift being distinct from the first phase shift such that the second phase-shift modulated signal is diverse relative to the first phase-shift modulated signal.

11. The base station of claim 10, wherein the first phase shift comprises a first constant phase shift and a first time-variable phase shift of 180 peak deviation operable in a phase direction.

12. The base station of claim 10, wherein the first phase shift comprises a first constant phase shift and a first time-variable phase shift of 180 peak deviation operable in an ascending phase direction.

13. The base station of claim 10, wherein the first phase shift comprises a first constant phase shift and a first time-variable phase shift from 0 to 180 operable in an ascending phase direction.

14. The base station of claim 10, wherein the second phase shift comprises a second constant phase shift and a second time-variable phase shift of 180 peak deviation operable in a phase direction.

15. The base station of claim 10, wherein the second phase shift comprises a second constant phase shift and a second time-variable phase shift of 180 peak deviation operable in a descending phase direction.

16. The base station of claim 10, wherein each of the first and second phase-shift elements comprises a phase-shift element operable to provide a phase shift of 180 peak deviation.

17. The base station of claim 10, wherein each of the first and second phase-shift elements comprises a ferrite phase-shift circuit.

18. The base station of claim 10, wherein each of the first and second phase-shift elements comprises one of an open loop linearization and compensation circuit and a closed loop linearization and compensation circuit.

19. The base station of claim 10, wherein the first antenna comprises a main antenna.

20. The base station of claim 10, wherein the second antenna comprises a diversity antenna.

21. The base station of claim 10, wherein the phase controller comprises a phase controller adapted to provide a first control signal and a second control signal based on one of a reference signal of 19.6 Megahertz (MHz), a reference signal of an integer multiple of 1.2288 MHz, and a reference signal of an integer multiple of 50 Hz.

22. The base station of claim 10, wherein the phase controller comprises a four-port hybrid combination element, wherein the four-port hybrid combination element is operable to provide carrier combination.

23. The base station of claim 10, wherein the base station operates in accordance with a code division multiple access (CDMA) based communication protocol.

24. In a wireless communication system, the communication system for providing communication service for a plurality of mobile stations, wherein a processor operates in accordance with a computer program embodied on a computer-readable medium for providing transmit diversity, the computer program comprising:
a first routine that directs the processor to phase-shift modulate a first signal with a first control signal to produce a first phase-shift modulated signal including a first phase shift;
a second routine that directs the processor to phase-shift modulate a second signal with a second control signal to produce a second phase-shift modulated signal including a second phase shift, the second phase shift being distinct from the first phase shift such that the second phase-shift modulated signal is diverse relative to the first phase-shift modulated signal;
a third routine that directs the processor to transmit the first phase-shift modulated signal via a first antenna; and
a fourth routine that directs the processor to transmit the second phase-shift modulated signal via a second antenna,
wherein the first control signal is synchronized with the second control signal.

25. The computer program of claim 24, wherein the first routine comprises a routine that directs the processor to phase-shift modulate a first signal with a first control signal to produce a first phase-shift modulated signal including a first constant phase shift and a first time-variable phase shift of 180 peak deviation operable in a phase direction.

27. The computer program of claim 24, wherein the first routine comprises a routine that directs the processor to phase-shift modulate a first signal with a first control signal to produce a first phase-shift modulated signal including a first constant phase shift and a first time-variable phase shift of 180 peak deviation operable in an ascending phase direction.

28. The computer program of claim 24, wherein the second routine comprises a routine that directs the processor to phase-shift modulate a second signal with a second control signal to produce a second phase-shift modulated signal including a second constant phase shift and a second time-variable phase shift of 180 peak deviation operable in a phase direction.

29. The computer program of claim 24, wherein the second routine comprises a routine that directs the processor to phase-shift modulate a second signal with a second control signal to produce a second phase-shift modulated signal including a second constant phase shift and a second time-variable phase shift of 180 peak deviation operable in a descending phase direction.

30. The computer program of claim 24, wherein the third routine comprises a routine that directs the processor to transmit the first phase-shift modulated signal via a main antenna.

31. The computer program of claim 23, wherein the fourth routine comprises a routine that directs the processor to transmit the second phase-shift modulated signal via a diversity antenna.

32. The computer program of claim 24 further comprising a fifth routine, the fifth routine comprising a routine that directs to processor to combine a first input signal and a second input signal to produce a composite signal and a routine that directs the processor to generate the first signal and the second signal based on the composite signal, wherein the first signal is based on a first carrier and the second signal is based on a second carrier.

33. The computer program of claim 24, wherein the computer program operates in accordance with a code division multiple access (CDMA) based communication protocol.

34. The computer program of claim 24, wherein the medium comprises one of paper, a programmable gate array, application specific integrated circuit, erasable programmable read only memory, read only memory, random access memory, magnetic media, and optical media.
